(19) United States
(12) Patent Application Publication
(10) Pub. No.: US 2010/0303472 A1
(43) Pub. Date: Dec. 2, 2010

(54) APPARATUS AND METHOD FOR ADAPTIVELY CONTROLLING THE IMPULSE RESPONSE OF THE OPTICAL SIGNAL OUTPUT FROM A LASER OF AN OPTICAL TRANSMITTER (TX)

(75) Inventors: Frederick W. Miller, Santa Clara, CA (US); Ron Kaneshiro, Los Altos, CA (US)

Correspondence Address: Kathy Manke;Avago Technologies Limited, 4380 Ziegler Road, Fort Collins, CO, 80525, US

(73) Assignee: Avago Technologies Fiber IP(Singapore) Pte. Ltd., Singapore (SG)

(21) Appl. No.: 12/474,433

(22) Filed: May 29, 2009

(51) Int. Cl. H04B 10/04

(52) U.S. Cl. 398/195

(57) ABSTRACT

An apparatus and a method are provided for adaptively adjusting the impulse response of the optical output of the laser of the optical TX in a way that ensures that the optical waveform being transmitted from the optical TX into the optical waveguide of the optical link has a desired waveform shape that improves or optimizes the performance of the optical link across variations in temperature, power supply, laser process corners, IC process corners, component aging, mechanical manufacturing tolerances, and part alignment tolerances. Adaptively adjusting the impulse response of the optical signal output from the laser in this way allows the optical TX to dynamically adapt to and compensate for a wide range of factors that typically cause performance degradation and result in reduced product yields, increased testing times, and increased test complexity, and higher costs. This, in turn, allows manufacturing tolerances and alignment tolerances to be relaxed, test times and test complexity to be reduced, and overall manufacturing and testing costs to be reduced.

### TECHNICAL FIELD OF THE INVENTION

The invention relates to optical communications devices. More particularly, the invention relates to an apparatus and a method for automatically adjusting the impulse response of the optical signal output from a laser of an optical transmitter or optical transceiver.

### BACKGROUND OF THE INVENTION

An optical transceiver module is an optical communications device used to transmit and receive optical data signals over optical waveguides (e.g., optical fibers) of an optical communications network. An optical transceiver module includes a transmitter (TX) portion and a receiver (RX) portion. The TX portion of an optical transceiver module includes input circuitry, a laser driver circuit, at least one laser diode, and an optics system. The input circuitry typically includes buffers and amplifiers for conditioning an input data signal, which is then provided to the laser driver circuit. The laser driver circuit receives the conditioned input data signal and produces electrical modulation and bias current signals, which are provided to the laser diode to cause it to produce optical data signals having logic 1 and logic 0 intensity levels corresponding to the electrical bits contained in the input data signal. The optical data signals are then directed by the optics system of the TX portion onto the ends of respective transmit optical fibers held within a connector that mates with the optical transceiver module.

An optical TX module or the TX portion of an optical transceiver module typically also include an open loop or closed loop optical output power control system that monitors and controls the modulation and/or bias currents of the laser diodes in such a way that the average optical output power levels of the laser diodes are maintained at substantially constant levels. Open loop optical output power control systems do not directly measure the optical output power levels of the laser diodes, but rather, rely on temperature, age and/or other parameters to determine adjustments that need to be made to the bias and/or modulation currents of the laser diodes to maintain their average optical output power levels substantially constant. Closed loop optical output power control systems use monitor photodiodes in the TX portion to monitor the output power levels of the laser diodes and feedback circuitry to produce control signals that are then used to adjust the modulation and/or bias currents of the laser diodes such that their average optical output power levels are maintained at substantially constant levels. Closed loop optical output power control systems are generally more accurate than open loop optical output power control systems due to the fact that closed loop systems react in real time based on real time measurements to make the necessary adjustments to the modulation and/or bias currents of the laser diodes.

FIG. 1 illustrates a block diagram of a typical TX portion 21 of an optical transmitter or transceiver module that includes a closed loop optical output power control system. The TX portion 21 includes a buffer 31, a pre-drive amplifier 32, a laser driver circuit 33, and a laser diode 34. The TX portion 21 typically also includes an optics system (not shown) for directing the light produced by the laser diode 34 onto the end of a transmit optical fiber (not shown). For ease of illustration, the optics system of the TX portion 21 is not shown in FIG. 1. The buffer 31 receives an input data signal at its input and adds some gain to the input data signal. The pre-drive amplifier 32 adds some additional gain to the input data signal and provides an output signal to the laser driver circuit 33. The laser driver circuit 33 provides a modulation current and a bias current to the laser diode 34 based on the amplified input data signal output from the pre-drive amplifier 33 that cause the laser diode 34 to produce optical output signals having logic 0 and logic 1 power levels that represent the logic 0 and logic 1 electrical bits, respectively, contained in the input data signal.

The closed loop optical output power control system of the TX portion 21 comprises a optical output power feedback control loop made up of a monitor photodiode 22, a transimpedance amplifier (TIA) 23, a low pass filter (LPF) 24, a power monitoring circuit (PMC) 25, an analog-to-digital converter (ADC) 26, and a controller device 27. The monitor photodiode 22 detects the optical data signals produced by the laser diode 34 and produces corresponding electrical current signals. The TIA 23 detects the electrical current signals produced by the photodiode 22 and produces an output voltage signal, which is integrated by the LPF 24 to produce an average voltage level. The PMC 25 receives the average voltage level produced by the LPF 24 and outputs an analog voltage level value indicative of the average optical output power level of the laser diode 34. The analog power level value is input to the ADC 26, which converts the analog value into a digital value and provides the digital value to the controller device 27.

The controller device 27 is configured to perform various algorithms to control the TX portion 21. One of these algorithms uses the digital value representing the average optical output power level of the laser diode 34 to produce one or more laser control signals, which are delivered to the laser driver circuit 33. The laser control signals are adjusted by the controller device 27 based on the digital value corresponding to the detected average optical output power level value received by the controller device 27 from the ADC 26. These adjustments cause the laser driver circuit 33 to adjust the bias and/or modulation currents of the laser diode 34 such that the average optical output power level of the laser diode 34 is maintained at a substantially constant level. The controller device 27 also produces an Enable signal that can be used to enable/disable the laser diode 34 based on a control algorithm, external signal, or fault monitoring circuits (not shown).

Closed loop algorithms similar to that described above with reference to FIG. 1 are also used to control other characteristics of the TX laser, such as, for example, the laser's extinction ratio, and to compensate for temperature and aging. In addition to these types of closed loop algorithms, open loop pre-distortion or pre-equalization circuits are sometimes used to shape the input current signal to the laser diode 34. Such open loop pre-distortion or pre-equalization circuits do not use feedback from the monitor photodiode 22 to emphasize or de-emphasize the amplitude of the electrical current signal delivered to the input of the laser diode 34. Such emphasizing or de-emphasizing of the amplitude of the electrical signal delivered to the laser diode 34 is often referred to as “laser peaking”, and uses a pulse to add or subtract current from the rising and/or falling edge of the electrical signal. The goal is to balance the rise/fall times of the signal to improve the eye opening of the optical signal. In some cases, information is obtained from the optical RX or transceiver on the opposite end of the optical link and used to adjust the extent to which the electrical signal delivered to the laser diode is emphasized or de-emphasized by the pre-distortion or pre-equalization circuit.

### SUMMARY OF THE INVENTION

The invention is directed to a method and apparatus for use in an optical TX for controlling the impulse response of the optical signal produced by at least one laser of the optical TX. The optical TX comprises an input buffer, a first filter circuit, a laser driver circuit, at least one laser diode, a monitor photodiode, a TX high-speed (HS) amplifier, a second filter circuit, an error function block, and an algorithm and control logic block (ACB). The input buffer receives an electrical input data signal and to output an electrical transmit (TX) signal. The first filter circuit receives the electrical TX signal and provides the electrical TX signal with a particular impulse response waveform. The first filter is an adaptive filter circuit having multiple taps and multiple respective tap weights that are adjustable. The laser driver circuit receives the electrical TX signal having the particular impulse response waveform and produces an electrical driver signal having a particular impulse response waveform. The laser diode receives the electrical driver signal and produces an optical signal having a particular impulse response waveform. The monitor photodiode detects at least a portion of the optical signal produced by the laser diode and produces an electrical detection signal. The TX HS amplifier receives the electrical detection signal and produces an HS electrical output signal. The second filter circuit receives the HS electrical output signal and measures the impulse response of the HS electrical output signal. The second filter circuit has multiple taps and multiple respective tap weights. The error function block receives the measured impulse response and performs an error function to produce an error value corresponding to a difference between the measured impulse response and a preselected impulse response. The ACB performs an adaptive impulse response algorithm that adjusts one or more of the tap weights of the first filter circuit based on the error value produced by the error function block, which results in the desired impulse response of the optical signal being produced by the laser diode being adjusted.

The method comprises the following. In an input buffer, receiving an electrical input data signal and outputting an electrical TX signal. In a first filter circuit, receiving the electrical TX signal and providing the electrical TX signal with a particular impulse response waveform. In a laser driver circuit, receiving the electrical TX signal having the particular impulse response waveform and producing an optical signal having a particular impulse response waveform. In a monitor photodiode, detecting at least a portion of the optical signal produced by the laser diode and producing an electrical detection signal. In a TX HS amplifier, receiving the electrical detection signal and producing an HS electrical output signal. In a second filter circuit, receiving the HS electrical output signal and measuring the impulse response of the HS electrical output signal. In an error function block, receiving the measured impulse response and performing an error function to produce an error value corresponding to a difference between the measured impulse response and a preselected impulse response. In an algorithm and control block (ACB), performing an adaptive impulse response algorithm that adjusts one or more of the tap weights of the first filter circuit based on the error value produced by the error function block. The adjustments of one or more of the tap weights of the first filter circuit results in the desired impulse response of the optical signal being produced by the laser diode being adjusted.

These and other features and advantages of the invention will become apparent from the following description, drawings and claims.

### BRIEF DESCRIPTION OF THE DRAWINGS

FIG. 1 illustrates a block diagram of a known optical TX that uses optical feedback from the laser of the TX to control the average optical output power of the laser.

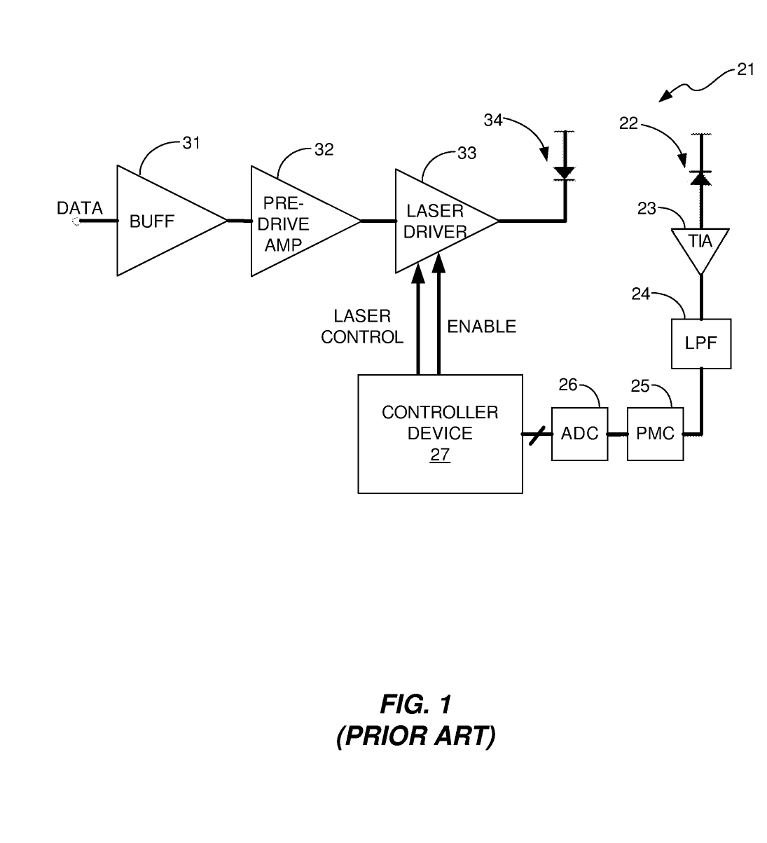

FIG. 2 illustrates a block diagram of an optical TX in accordance with an embodiment of the invention having an apparatus for adaptively adjusting the impulse response of the optical signal output from the laser of the optical TX.

FIG. 3 illustrates a block diagram of an optical transceiver in accordance with an embodiment of the invention having an apparatus for adaptively adjusting the impulse response of the optical signal output from the laser of the optical transceiver.

FIG. 4 illustrates a flowchart representing an embodiment for adaptively adjusting the impulse response of the optical signal output from the laser of an optical TX such as that shown in FIG. 2.

FIG. 5 illustrates a flowchart representing an embodiment for adaptively adjusting the impulse response of the optical signal output from the laser of an optical transceiver such as that shown in FIG. 3.

### DETAILED DESCRIPTION OF AN ILLUSTRATIVE EMBODIMENT

In accordance with the invention, a closed loop apparatus and method are provided for adaptively adjusting the impulse response of the optical signal output from the laser of an optical TX based on optical feedback detected by at least one monitor photodiode that monitors the optical output signal produced by the laser of the optical TX. The optical TX may be a stand-alone optical TX or the TX portion of an optical transceiver. The optical transceiver or stand-alone optical TX may have a single TX channel that uses a single laser to produce an optical data signal and a single monitor photodiode to monitor the optical output power level of the laser diode. Alternatively, the optical transceiver or stand-alone optical TX may have a multiple TX channels that use multiple laser diodes to produce multiple optical data signals, and multiple monitor photodiodes that monitor the respective optical output signals produced by the respective laser. Therefore, the term “optical TX”, as that term is used herein, is intended to denote either a stand-alone optical TX that incorporates the apparatus and method or an optical transceiver that incorporates the apparatus and method, either of which may have a single laser diode and a single monitor photodiode or multiple laser diodes and multiple monitor photodiodes.

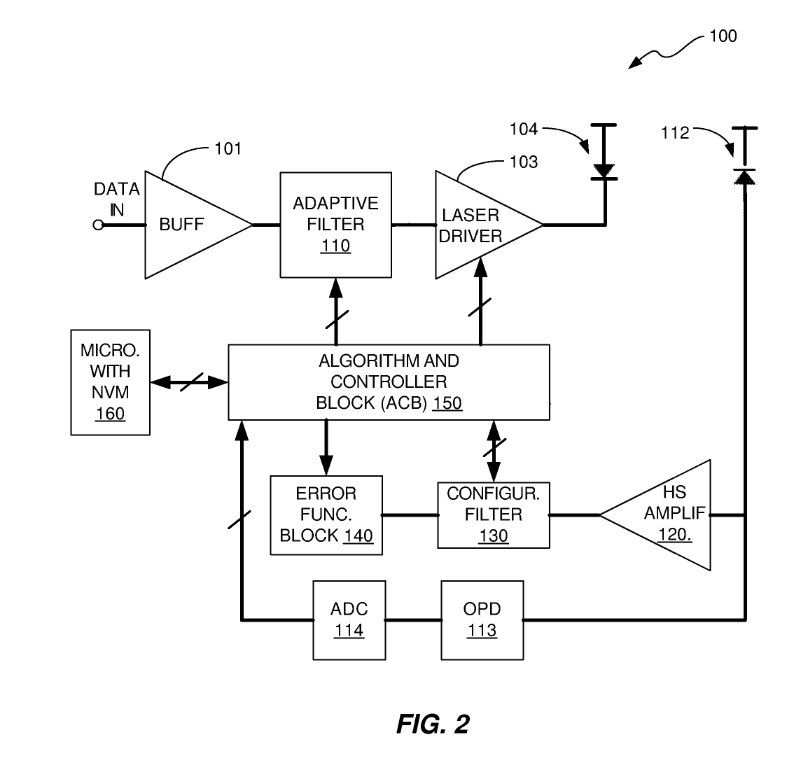

As will be described below in detail with reference to FIGS. 2-5, the apparatus and method of the invention enable adjustments to be made to the impulse response of the optical output of the laser of the optical TX in a way that ensures that the optical waveform being transmitted from the optical TX into the optical waveguide of the optical link has a desired waveform shape that improves or optimizes the performance of the optical link across variations in temperature, power supply, laser process corners, IC process corners, component aging, mechanical manufacturing tolerances, and part alignment tolerances. Adaptively adjusting the impulse response of the optical signal output from the laser in this way allows the optical TX to dynamically adapt to and compensate for a wide range of factors that typically cause performance degradation and result in reduced product yields, increased testing times, and increased test complexity, and higher costs. In this way, the invention enables manufacturing tolerances and alignment tolerances to be relaxed, enables test times and test complexity to be reduced, and enables overall manufacturing and testing costs to be reduced. In addition, the method and apparatus enable the optical waveform that is output from the TX to be adaptively shaped to have a desired shape that compensates for other link factors, such as optical fiber effects and limitations of the optical RX, which, in turn, enables the length of the optical link to be increased.

FIG. 2 illustrates a block diagram of an optical TX 100 in accordance with an embodiment for monitoring the optical signal output from a laser diode 104 of the optical TX and for adaptively adjusting the impulse response of the optical signal output from the laser diode 104 based on optical feedback detected by a monitor photodiode 112 of the optical TX 100. The optical TX 100 includes a buffer 101, a multi-tap adaptive filter 110, a laser driver circuit 103, and a laser diode 104. The optical TX 100 typically also includes an optics system (not shown) for directing the light produced by the laser diode 104 onto the end of a transmit optical fiber (not shown). For ease of illustration, the optics system of the optical TX 100 and the optical fiber are not shown in FIG. 2.

The optical TX 100 also includes the monitor photodiode 112, an optical power detector (OPD) 113, an analog-to-digital converter (ADC) 114, a high-speed (HS) amplifier 120, a configurable filter 130, an error function block 140, an algorithm and control block (ACB) 150, and a microcontroller 160 with non-volatile memory (NVM). The apparatus of the optical TX 100 for adaptively adjusting the impulse response of the optical signal output from the laser diode 104 based on optical feedback comprises the monitor photodiode 112, the HS amplifier 120, the configurable filter 130, the error function block 140, the ADC 114, the ACB 150, and the adaptive filter 110. The configurable filter 130 is a multi-tap filter having tap weights that are configurable, or adjustable. The HS amplifier 120 is an amplifier capable of detecting an optical signal having a frequency that is at least as high as the frequency of the electrical data signal received at the input of the laser driver circuit 103. A suitable amplifier for use as the HS amplifier 120 is a transimpedance amplifier (TIA).

The manner in which the optical TX 100 adaptively adjusts the impulse response of the optical signal output from the laser diode 104 based on optical feedback detected by the monitor photodiode 112 will now be described. When the optical TX 100 is powered up, the microcontroller 160 executes firmware that uses values stored in the NVM of the microcontroller 160 to set the tap weights of the filters 110 and 130 to preselected values and to set the coefficients of the error function of the error function block 140 to preselected values. The pre-selected values for the tap weights are intended to cause the filters 110 and 130 to provide the signals input thereto with waveforms that have particular desired impulse responses. The number of taps and the tap spacing for the configurable filter 130 are preselected to optimum values for the signal data rate, the desired width and shape of the impulse response, and the desired resolution. The adaptive and configurable filters 110 and 130, respectively, may be, for example, finite impulse response (FIR) filters, although other filter types may be used for this purpose. While, as indicated above, peaking circuits/filters have been used in the past in the signal path between the laser driver circuit and laser diode to perform laser peaking, filters used for that purpose are typically single-tap filters that add an amount of current to the rising and/or falling edge of the electrical signal to improve the optical eye opening. Such filters are not used in closed loop feedback systems that adapt the tap weights of the filters based on an optical signal produced by a laser diode and detected by a monitor photodiode.

After the optical TX 100 begins transmitting data, the buffer 101 adds some amount of gain to the input data signal, Data In, and the adaptive filter 110 shapes the signal it receives from the buffer 101 to have a particular impulse response based on the tap weights of the adaptive filter 110. The laser driver circuit 103 receives the electrical data signal having the shaped waveform at its input and modulates the laser diode 104 to cause it to produce corresponding optical data signals. The ACB 150 sets the modulation and/or bias currents of the laser diode 104 via the laser driver circuit 103. The monitor photodiode 112 detects the optical data signals output from the laser diode 104 and produces corresponding electrical signals. The electrical signal produced by the monitor photodiode 112 is received at the input of the HS amplifier 120. The HS amplifier 120 amplifies the electrical signal received at its input and outputs an amplified electrical signal. The amplified electrical signal is then input to the configurable filter 130.

The configurable filter 130 filters the waveform of the electrical signal input thereto and outputs an electrical signal having a particular impulse response waveform that is based on the tap weights of the filter 130 and the waveform of the electrical signal received at the input of the filter 130. The filtered signal that is output from the configurable filter 130 is input to the error function block 140. The error function block 140 receives the filtered signal and produces an analog error value equal to the difference between the waveform of the filtered signal and the error function waveform. This analog error value is then input to the ADC 114, which converts the analog error value into a digital error value. The digital error value is then input to the ACB 150.

The ACB 150 is a state machine comprising a combination of digital logic gates configured to perform algorithms that control various operations of the optical TX 100. This type of control block is often used in optical transmitters and transceivers. However, in addition to the algorithms typically performed by the control block, the ACB 150 also performs an impulse response adaptation algorithm that adjusts the tap weights of the adaptive filter 110 in real-time based on the digital error value received in the ACB 150 from the ADC 114. In particular, the ACB 150 adjusts the tap weights of the adaptive filter 110 such that the digital error value output from the ADC 114 and input to the ACB 150 is minimized or at least reduced. The difference between the waveform of the signal that is output from adaptive filter 110 and the waveform of the signal that is input to the configurable filter 130 is due to the characteristics of the laser diode 104 and its operating conditions. As the tap weights of the adaptive filter 110 are adjusted by the ACB 150 based on the digital error value output from the ADC 114, the difference between the impulse response waveform that is output from the adaptive filter 110 and the impulse response waveform that is output from the configurable filter 130 is reduced. Thus, the ACB 150 adjusts the tap weights of the adaptive filter 110 in a direction that causes the digital error value to be minimized or reduced.

As indicated above, one of the advantages provided by the method and apparatus of the invention is that they reduce the amount of testing that is needed during production. For example, the jitter and mask margin testing that are normally performed during production testing are no longer needed due to the fact that the optical TX 100 measures its own impulse response and determines whether or not the filters 110 and 130 have enough range to provide satisfactory performance to compensate for aging and environmental changes over the intended lifetime of the optical TX 100. The active, real-time control provided by the method and apparatus provide greater adaptive range than that which is typically provided by known laser control systems. Consequently, more compensation is achievable with the TX 100, which results in an increase in manufacturing yield while also improving the robustness and reliability of the TX 100 in the field.

The OPD 113 is a low-speed circuit that measures the average optical output power of the laser diode 104 and produces an electrical signal at its output representative of the average optical output power of the laser diode 104. The ADC 114 converts this analog average value into a digital average value, which is then input to the ACB 150. The ACB 150 performs an optical output power control algorithm that adjusts the modulation and/or bias currents of the laser driver circuit 103 in such a way that the optical output power level of the laser diode 104 is maintained at a substantially constant level. Closed loop optical output power control algorithms that are suitable for this purpose are known in the art. Alternatively, an open loop optical output power control algorithm could be used for this purpose, although closed loop algorithms are preferred as they tend to achieve better performance. Using the adaptive impulse response algorithm of the invention in combination with a suitable optical output power control algorithm helps ensure that the optical signal output from the laser diode 104 will have the desired waveform that optimizes the performance of the optical TX 100 and of the optical link in which the optical TX 100 is employed. It should be noted, however, that the invention is not limited with respect to the power control algorithm that is used, or with respect to whether or not a power control algorithm is used at all.

Once the optical TX 100 has been initialized and has gone through its initial adaptation of the tap weights of the adaptive filter 110, it typically will not be necessary for the ACB 150 to make a large number of changes to the tap weights of the adaptive filter 110. The reason for this is that the factors that cause the waveform that is output from the laser diode 104 to change typically happen at very slow rates. Therefore, the circuits associated with performing the adaptive impulse response algorithm can be powered off most of the time. Power cycling of these circuits on a fixed or variable schedule can reduce the additional power dissipation associated with these circuits to a negligible level.

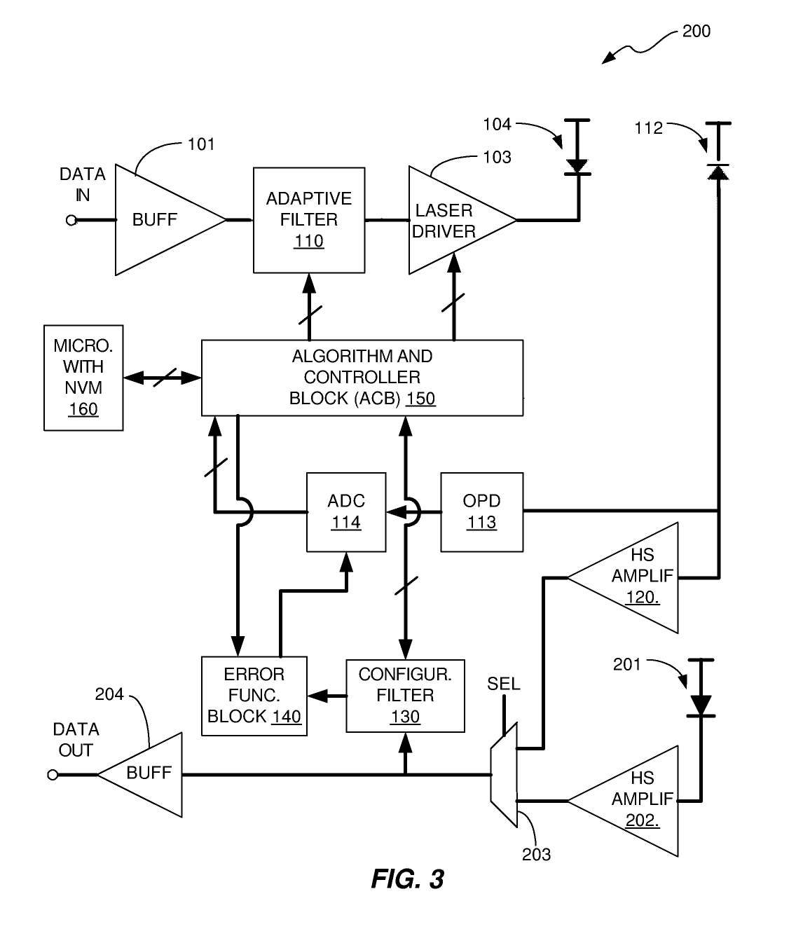

FIG. 3 illustrates a block diagram of an optical transceiver 200 in accordance with an embodiment in which the adaptive impulse response algorithm is performed partially in the RX of the transceiver 200 and partially in the TX of the transceiver 200. The components in FIG. 3 that have the same reference numerals as those in FIG. 2 perform the same functions as those described above with reference to FIG. 2. The RX of the transceiver 200 includes a receiver photodiode 201, an HS amplifier 202, a multiplexer (MUX) 203, the configurable filter 130 described above with reference to FIG. 2, the error function block 140 described above with reference to FIG. 2, and an output buffer 204. The receiver photodiode 201 and the HS amplifier 202 may be identical to the monitor photodiode 112 and the HS amplifier 120, respectively, described above with reference to FIG. 2.

In accordance with the embodiment represented by FIG. 3, the adaptive impulse response algorithm is only performed when the transceiver 200 is powered up and when the transceiver 200 is re-enabled after being disabled. The reason for this is that the receive channel cannot be used to receive actual data while the adaptive impulse response algorithm is being performed. When the transceiver 200 is initially powered up or is re-enabled after being disabled, the ACB 150 deasserts the select signal, SEL, provided to the MUX 203. Deassertion of SEL causes the MUX 203 to the select the output of HS amplifier 120 to be output from the MUX 203. The configurable filter 130, the error control block 140, the ACB 150, and the adaptive filter 110 then perform the algorithms described above with reference to FIG. 2 to adapt the impulse response of the output of the laser diode 104 based on the optical signal detected by the monitor photodiode 112. After the adaptive impulse response algorithm has been performed on the optical transceiver 200, the ACB 150 asserts SEL. Assertion of SEL causes the MUX 203 to select the output of the HS amplifier 202 to be output from the MUX 203. This signal is then received at the input of the output buffer 204, which adds some gain to the signal before outputting the signal at the Data Out terminal as the output data signal. The operations performed by the receiver photodiode 201, the receiver HS amplifier 202, and the output buffer 204 are the typical receiver operations performed in the RX portion of an optical transceiver.

The optical transceiver 200 has the same advantages as those described above with reference to the optical TX 100 shown in FIG. 2. Performance of the adaptive impulse response algorithm in the optical transceiver 200 improves or optimizes the performance of the optical link across variations in temperature, power supply, laser process corners, IC process corners, component aging, mechanical manufacturing tolerances, and part alignment tolerances. Adaptively adjusting the impulse response of the optical signal output from the laser diode 104 in this way allows the optical transceiver 200 to dynamically adapt to and compensate for a wide range of factors that typically cause performance degradation and result in reduced product yields, increased testing times, and increased test complexity, and higher costs. This enables the manufacturing tolerances and alignment tolerances to be relaxed, the test times and test complexity to be reduced, and the overall manufacturing and testing costs to be reduced. In addition, adaptively shaping the input data signal to the optical transceiver 200 enables the input data signal to have a desired shape that compensates for other link factors, such as optical fiber effects and limitations of the optical RX on the other end of the optical link, which, in turn, enables the length of the optical link to be increased.

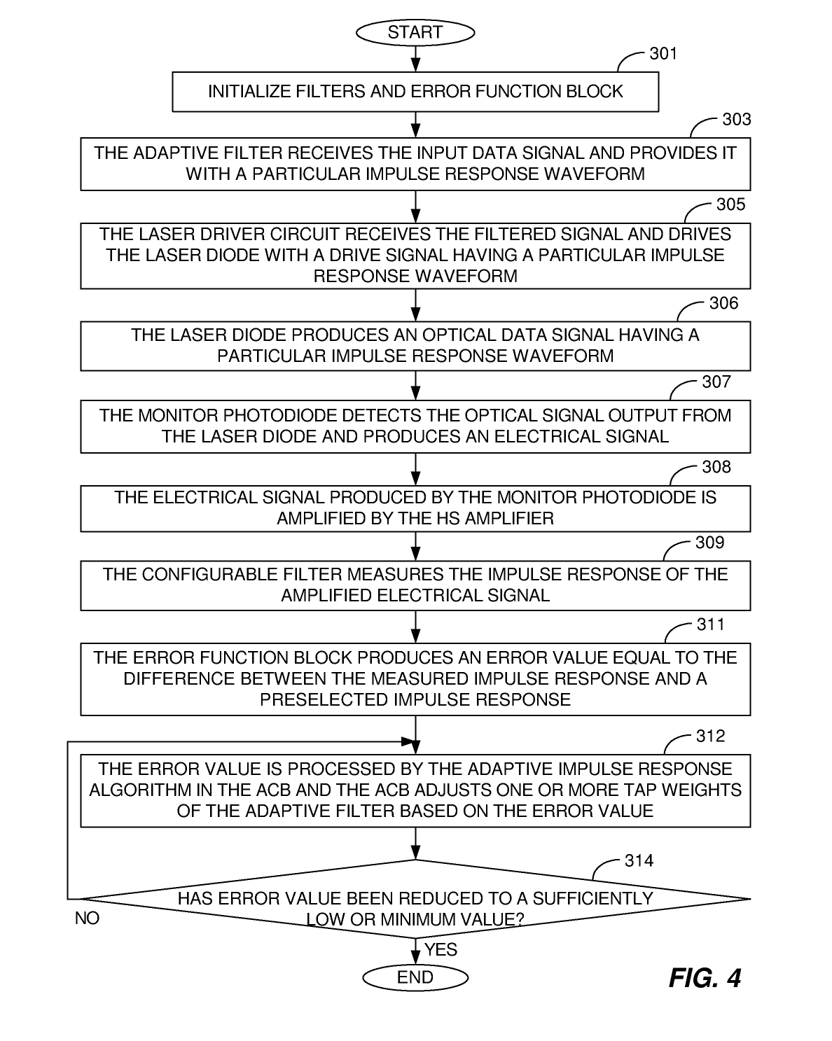

FIG. 4 illustrates a flowchart that represents the method in accordance with an embodiment for adaptively varying the impulse response of the optical signal produced by a laser diode of an optical TX, such as that shown in FIG. 2, until the optical signal produced by the laser diode has a desired impulse response. For illustrative purposes, the method will be described also with reference to the optical TX 100 shown in FIG. 2. At power up of the optical TX 100, the tap weights of the adaptive and configurable filters 110 and 130 and the coefficients of the error function block 140 are set to their initial values, as indicated by block 301. After power up, as the input data signal is received at the input of the adaptive filter 110, the adaptive filter 110 provides the input data signal with an impulse response waveform in accordance with the tap weights of the adaptive filter 110, as indicated by block 303. The laser driver circuit 103 receives the impulse response waveform produced by the adaptive filter 110 and drives the laser diode 104 with a drive signal that has a particular impulse response waveform, as indicated by block 305. The laser diode 104 produces an optical signal at its output that has an impulse response that is based on the impulse response of the signal that is used by the laser driver circuit 103 to drive the laser diode 104, as indicated by block 306.

The monitor photodiode 112 detects at least a portion of the optical signal produced by the laser diode 104 and produces an output electrical signal, as indicated by block 307. The HS amplifier 120 detects the electrical signal produced by the monitor photodiode 112 and produces an amplified electrical signal, as indicated by block 308. The configurable filter 130 receives the amplified electrical signal and measures the impulse response of the amplified electrical signal, as indicated by block 309. The error function block 140 receives the measured impulse response from the configurable filter 130 and obtains the error value corresponding to the difference between the measured impulse response and the impulse response defined by the error function, as indicated by block 311. The error value is processed by the adaptive impulse response algorithm to calculate any adjustments that are to be made to the tap weights of the adaptive filter 110, and the tap weights of the adaptive filter 110 are adjusted accordingly, as indicated by block 312. A determination is then made at decision block 314 as to whether the error value produced by the error function block 140 has been reduced to a sufficiently low value or to a minimum value.

When the error value has been sufficiently reduced or minimized, the tap weights of the adaptive filter 110 will generally represent the inverse of the impulse response measured by the configurable filter 130, depending on the manner in which the adaptive impulse response algorithm is implemented (i.e., whether the algorithm is intended to obtain a minimum error value or merely to obtain an error value that is close to the minimum error value). The goal of the adaptive impulse response algorithm is for the measured impulse response obtained by the configurable filter 130 to match as closely as possible the desired impulse response of the optical signal produced by the laser diode 104. The algorithm accomplishes this goal by iteratively adjusting the tap weights of the adaptive filter 110 until the error value has been reduced to a sufficiently low or predetermined value. Thus, if the decision that is made by block 314 is answered in the affirmative, the adaptive algorithm ends; otherwise, the algorithm returns to block 312 and the process is reiterated until the decision that is made at block 314 is answered in the affirmative.

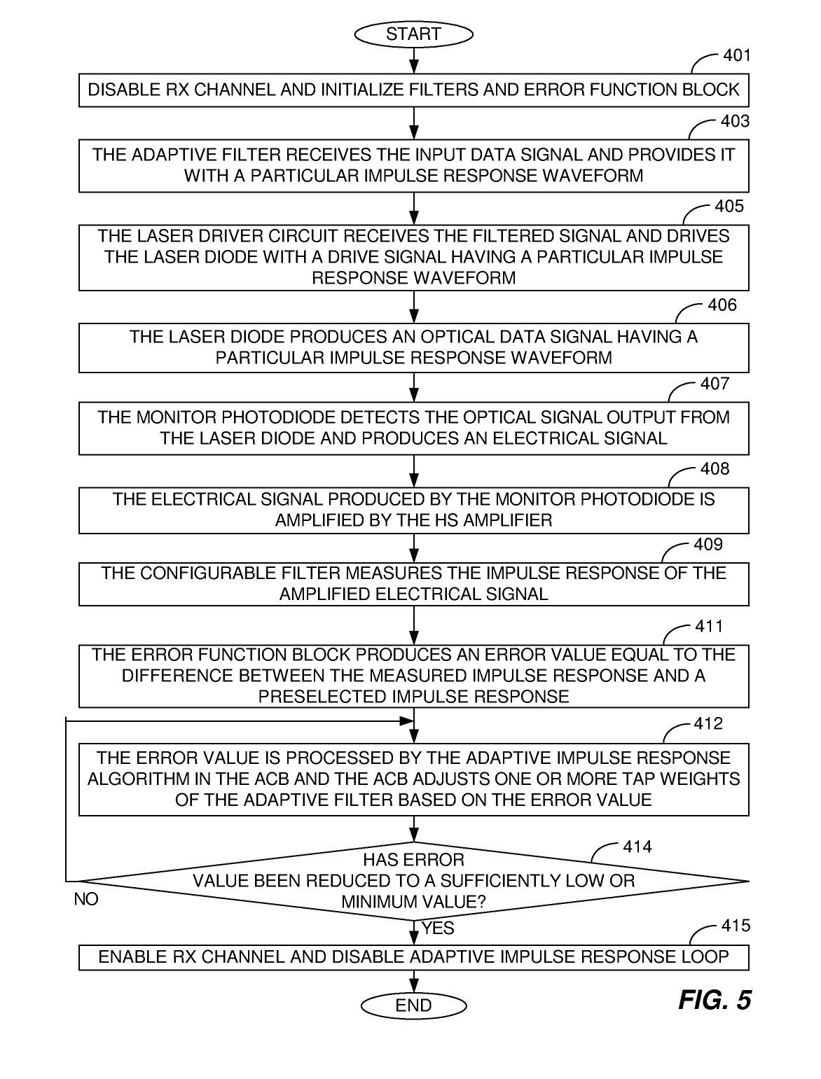

FIG. 5 illustrates a flowchart that represents the method in accordance with an embodiment for adaptively varying the impulse response of the optical signal produced by a laser diode of a TX portion of an optical transceiver, such as that shown in FIG. 3. For illustrative purposes, the method will be described also with reference to the optical transceiver 200 shown in FIG. 3. At power up of the optical transceiver 200, the RX channel of the transceiver 200 is disabled (SEL deasserted) and the tap weights of the adaptive and configurable filters 110 and 130 and the coefficients of the error function block 140 are set to their initial values, as indicated by block 401. The input data signal is received at the input of the adaptive filter 110, which provides the input data signal with an impulse response waveform in accordance with the tap weights of the adaptive filter 110, as indicated by block 403. The laser driver circuit 103 receives the impulse response waveform produced by the adaptive filter 110 and drives the laser diode 104 with the impulse response waveform, as indicated by block 405. The laser diode 104 produces an optical signal at its output that has an impulse response that is based on the impulse response of the signal that is used by the laser driver circuit 103 to drive the laser diode 104, as indicated by block 406.

The monitor photodiode 112 detects at least a portion of the optical signal produced by the laser diode 104 and produces an output electrical signal, as indicated by block 407. The HS amplifier 120 detects the electrical signal produced by the monitor photodiode 112 and produces an amplified electrical signal, as indicated by block 408. The configurable filter 130 receives the amplified electrical signal and measures the impulse response of the amplified electrical signal, as indicated by block 409. The error function block 140 receives the measured impulse response from the configurable filter 130 and obtains the error value corresponding to the difference between the measured impulse response and the impulse response defined by the error functions, as indicated by block 411. The error value is processed by the adaptive impulse response algorithm (ACB 150) to determine if any adjustments need to be made to the tap weights of the adaptive filter 110, and the tap weights are adjusted accordingly, as indicated by block 412. A determination is then made at decision block 414 as to whether the error value produced by the error function block 140 has been reduced to a sufficiently low value or to a minimum value.

As indicated above with reference to FIG. 4, when the error value has been sufficiently reduced or minimized, the impulse response corresponding to the tap weights of the adaptive filter 110 will generally represent the inverse of the impulse response measured by the configurable filter 130, depending on the manner in which the adaptive impulse response algorithm is implemented. The goal of the adaptive impulse response algorithm is for the measured impulse response obtained by the configurable filter 130 to match as closely as possible the desired impulse response of the optical signal produced by the laser diode 104. The algorithm accomplishes this goal by iteratively adjusting the tap weights of the adaptive filter 110 until the error value has been reduced to a sufficiently low value or minimized. If the decision that is made by block 414 is answered in the affirmative, the algorithm proceeds to block 415 at which the RX channel is enabled (SEL asserted) and the adaptive impulse response feedback loop is disabled. Disabling the adaptive impulse response feedback loop prevents the ACB 150 from updating the tap weights of the adaptive filter 110. Even after the adaptive impulse response feedback loop has been disabled, the optical power control loop (components 112, 113, 114, and 150) will typically continue to operate to enable the ACB 150 to adjust the modulation and/or bias currents of the laser driver circuit 103 to maintain the average optical output power of the laser diode 104 at a substantially constant level.

After the adaptive impulse response feedback loop has been disabled and the RX channel has been enabled, the process ends. If the decision that is made at block 414 is not answered in the affirmative, the algorithm returns to block 412 and the process is reiterated until the decision that is made at block 414 is answered in the affirmative, at which point the process proceeds to block 415 where the RX channel is enabled and the adaptive impulse response feedback loop is disabled.

It should be noted that many modifications may be made to the algorithms represented by the flowcharts shown in FIGS. 4 and 5 while still achieving the objectives of the invention. For example, rather than configuring the configurable filter 130 and the error function block 140 at power up using values stored in the NVM of the microcontroller 160, these components may be pre-configured with fixed settings that are preselected to achieve the desired results. However, by using firmware to configure these components with values stored in the NVM of the microcontroller 160, the manner in which the adaptive impulse response algorithm is performed can be easily varied to achieve better performance by simply varying the settings stored in the NVM of the microcontroller 160. In addition, although FIGS. 2 and 3 show multiple separate components for performing the adaptive impulse response algorithm, these components may be integrated into a single IC or multiple ICs and/or implemented by one or more discrete devices. Also, although the ACB 150 that performs the adaptive impulse response algorithm is typically a state machine, the algorithm may instead be performed in software or a combination of software and firmware executed by a processing device, such as the microcontroller 160 or some other processing device, such as a microprocessor (not shown), for example. If the algorithm is performed in software or a combination of software and firmware, the corresponding computer code will be stored in some type of computer-readable medium, such as a solid state memory device, for example.

It should be noted that the invention has been described with respect to illustrative embodiments for the purpose of describing the principles and concepts of the invention. The invention is not limited to these embodiments. For example, while the invention has been described with reference to using a particular optical TX or transceiver configuration, the invention is not limited to these particular configurations. For example, there may be additional components other than the adaptive filter 110 in the signal path between the output of the input buffer 101 and the input of the laser driver circuit 103 for further conditioning the signal. Likewise, there may be additional components other than those shown in the adaptive impulse response and power monitoring feedback loops. As will be understood by those skilled in the art in view of the description being provided herein, these and other modifications may be made to the embodiments described herein without deviating from the goals of the invention, and all such modifications are within the scope of the invention.

What is claimed is:

1. An apparatus for use in an optical transmitter (TX) for controlling an impulse response of an optical signal produced by at least one laser of the optical TX, the apparatus comprising:
an input buffer that receives an electrical input data signal and outputs an electrical transmit (TX) signal;
a first filter circuit that receives the electrical TX signal and provides the electrical TX signal with a particular impulse response waveform, the first filter being an adaptive filter circuit having multiple taps and multiple respective tap weights that are adjustable;
a laser driver circuit that receives the electrical TX signal having the particular impulse response waveform and producing an electrical driver signal having a particular impulse response waveform;
at least one laser diode that receives the electrical driver signal and produces an optical signal in response to the electrical driver signal, the optical signal having a particular impulse response waveform;
a monitor photodiode that detects at least a portion of the optical signal produced by the laser diode and produces an electrical detection signal;
a TX high-speed (HS) amplifier that receives the electrical detection signal and produces an HS electrical output signal;
a second filter circuit that receives the HS electrical output signal and measures an impulse response of the HS electrical output signal, the second filter circuit having multiple taps and multiple respective tap weights;
an error function block configured that receives the measured impulse response and performs an error function that produces an error value corresponding to a difference between the measured impulse response and a preselected impulse response; and
an algorithm and control logic block (ACB) that performs an adaptive impulse response algorithm that adjusts one or more of the tap weights of the first filter circuit based on the error value produced by the error function block, wherein the adjustment of one or more of the tap weights of the first filter circuit causes the impulse response of the optical signal produced by the laser diode to be adjusted.

2. The apparatus of claim 1, wherein the ACB iteratively adjusts one or more of the tap weights of the first filter circuit until the error value produced by the error function block has been reduced to a predetermined error value.

3. The apparatus of claim 2, wherein the predetermined value is a minimum value for the error value.

4. The apparatus of claim 1, wherein the first and second filter circuits are first and second finite impulse response (FIR) filters, respectively.

5. The apparatus of claim 1, further comprising:
a microcontroller having non-volatile memory (NVM) element, the NVM element storing settings for initializing the tap weights of the first and second filters and coefficients of the error function of the error function block.

6. The apparatus of claim 1, further comprising:
a relatively low-speed optical power detector (OPD) configured to receive the electrical detection signal produced by the monitor photodiode and to produce an average electrical signal corresponding to an average of optical power of the optical signal produced by the laser diode, wherein the ACB performs an average power control algorithm that adjusts at least one of a modulation current and a bias current of the electrical driver signal produced by the laser driver circuit based on the average electrical signal produced by the OPD.

7. The apparatus of claim 6, wherein the optical TX is part of an optical transceiver, the optical transceiver further comprising:
a receiver (RX) channel, the RX channel comprising:
a receiver photodiode configured to receive an optical data signal transmitted to the optical transceiver over an optical waveguide and to convert the received optical data signal into an electrical received data signal;
an RX HS amplifier configured to receive the electrical received data signal and to produce an HS electrical received signal;
a multiplexer (MUX) circuit configured to receive the electrical received data signal produced by the RX HS amplifier at a first input of the MUX circuit and to receive the HS electrical output signal produced by the TX HS amplifier at a second input of the MUX circuit, the MUX circuit receiving a selection signal (SEL) that causes the MUX circuit to select the first input of the MUX circuit when SEL is asserted and to select the second input of the MUX circuit when SEL is deasserted, the MUX circuit having an output that outputs the electrical received data signal produced by the RX HS amplifier when SEL is asserted and that outputs the HS electrical output signal produced by the TX HS amplifier when SEL is deasserted; and
an RX output buffer configured to receive the electrical signal on the output of the MUX circuit, wherein when SEL is asserted, the RX output buffer receives the electrical received data signal produced by the RX HS amplifier and outputs the electrical received data signal at an output of the RX output buffer; and
wherein the output of the MUX circuit is electrically coupled to the second filter circuit such that when SEL is deasserted, the second filter circuit receives the HS electrical output signal and produces the measured impulse response that is received in the error function block.

8. The apparatus of claim 7, wherein SEL is deasserted when the optical transceiver is powered up, and wherein after one or more of the tap weights of the first filter circuit have been adjusted, SEL is asserted.

9. The apparatus of claim 8, wherein after SEL has been asserted, the ACB stops adjusting one or more of the tap weights of the first filter circuit.

10. A method for adjusting an impulse response of an optical signal produced by at least one laser diode of an optical transmitter (TX), the method comprising:
receiving an electrical input data signal in an input buffer of the optical TX and outputting an electrical transmit (TX) signal from the data buffer;
in a first filter circuit of the optical TX, receiving the electrical TX signal and providing the electrical TX signal with a particular impulse response waveform, the first filter being an adaptive filter circuit having multiple taps and multiple respective tap weights that are adjustable;
in a laser driver circuit of the optical TX, receiving the electrical TX signal having the particular impulse response waveform and producing an electrical driver signal having a particular impulse response waveform;
in at least one laser diode of the optical TX, receiving the electrical driver signal and producing an optical signal in response to the electrical driver signal, the optical signal having a particular impulse response waveform;
in a monitor photodiode of the optical TX, detecting at least a portion of the optical signal produced by the laser diode and producing an electrical detection signal;
in a TX high-speed (HS) amplifier of the optical TX, receiving the electrical detection signal and producing an HS electrical output signal;
in a second filter circuit of the optical TX, receiving the HS electrical output signal and measuring an impulse response of the HS electrical output signal, the second filter circuit having multiple taps and multiple respective tap weights;
in an error function block of the optical TX, receiving the measured impulse response and performing an error function to produce an error value corresponding to a difference between the measured impulse response and a preselected impulse response; and
in an algorithm and control logic block (ACB) of the optical TX, performing an adaptive impulse response algorithm that adjusts one or more of the tap weights of the first filter circuit based on the error value produced by the error function block, wherein the adjustment of one or more of the tap weights of the first filter circuit causes the impulse response of the optical signal produced by the laser diode to be adjusted.

11. The method of claim 10, wherein the ACB iteratively adjusts one or more of the tap weights of the first filter circuit until the error value produced by the error function block has been reduced to a predetermined error value.

12. The method of claim 11, wherein the predetermined value is a minimum value for the error value.

13. The method of claim 9, wherein the first and second filter circuits are first and second finite impulse response (FIR) filters, respectively.

14. The method of claim 9, further comprising:
prior to performing the adaptive impulse response algorithm in the ACB, in a microcontroller of the optical TX, retrieving initial setting values for the tap weights of the first and second filters and for the coefficients of the error function of the error function block from a memory element and setting the tap weights of the first and second filter circuits and the coefficients of the error function to the respective initial setting values.

15. The method of claim 10, further comprising:
in a relatively low-speed optical power detector (OPD) of the optical TX, detecting the electrical detection signal produced by the monitor photodiode and producing an average electrical signal corresponding to an average optical power of the optical signal produced by the laser diode; and
in the ACB of the optical TX, performing an average power control algorithm that adjusts at least one of a modulation current and a bias current of the electrical driver signal produced by the laser driver circuit based on the average electrical signal produced by the OPD.

16. The method of claim 15, wherein the optical TX is part of an optical transceiver, the method further comprising:
in a receiver photodiode of a receiver (RX) channel of the optical transceiver, receiving an optical data signal transmitted to the optical transceiver over an optical waveguide and converting the received optical data signal into an electrical received data signal;
in an RX HS amplifier of the RX channel of the optical transceiver, receiving the electrical received data signal and producing an HS electrical received signal;
in a multiplexer (MUX) circuit of the RX channel of the optical transceiver, receiving the electrical received data signal produced by the RX HS amplifier at a first input of the MUX circuit and receiving the HS electrical output signal produced by the TX HS amplifier at a second input of the MUX circuit;
in the MUX circuit, receiving a selection signal (SEL), wherein SEL causes the MUX circuit to select the first input of the MUX circuit when SEL is asserted and to select the second input of the MUX circuit when SEL is deasserted, the MUX circuit having an output that outputs the electrical received data signal produced by the RX HS amplifier when SEL is asserted and that outputs the HS electrical output signal produced by the TX HS amplifier when SEL is deasserted; and
in an RX output buffer of the RX channel of the optical transceiver, receiving the electrical signal on the output of the MUX circuit, wherein when SEL is asserted, the RX output buffer receives the electrical received data signal produced by the RX HS amplifier and outputs the electrical received data signal at an output of the RX output buffer; and
in the second filter circuit of the optical transceiver, when SEL is deasserted, receiving the HS electrical output signal and producing the measured impulse response that is received in the error function block.

17. The method of claim 16, wherein SEL is deasserted when the optical transceiver is powered up, and wherein after one or more of the tap weights of the first filter circuit have been adjusted, SEL is asserted.

18. The method of claim 17, wherein after SEL has been asserted, the ACB stops adjusting one or more of the tap weights of the first filter circuit.
